(19) United States
(12) Patent Application Publication
(10) Pub. No.: US 2026/0312262 A1
(43) Pub. Date: Oct. 8, 2026

(54) ALL-SOLID RECHARGEABLE BATTERY

(71) Applicant: SAMSUNG SDI CO., LTD., Yongin-si, Gyeonggi-do (KR)

(72) Inventors: Jinah LEE, Yongin-si, Gyeonggi-do (KR); Jinhee MOON, Yongin-si, Gyeonggi-do (KR); Riyul KIM, Yongin-si, Gyeonggi-do (KR); Yong Chul SEO, Yongin-si, Gyeonggi-do (KR); Jihyoung PARK, Yongin-si, Gyeonggi-do (KR); Jeonga MINN, Yongin-si, Gyeonggi-do (KR)

(21) Appl. No.: 18/874,694

(22) PCT Filed: Apr. 4, 2024
(86) PCT No.: PCT/KR2024/095669

§ 371 Date: Dec. 13, 2024

(30) Foreign Application Priority Data
Nov. 1, 2023 (KR) 10-2023-0149242

(51) Int. Cl. H01M 50/593; H01M 10/0525; H01M 50/533; H01M 50/54; H01M 50/586

(52) U.S. Cl. CPC H01M 50/593; H01M 10/0525; H01M 50/533; H01M 50/54; H01M 50/586

(57) ABSTRACT

An all-solid rechargeable battery according to an embodiment includes: a stack cell including a plurality of battery cells that are stacked and include a plurality of negative electrodes, a plurality of solid electrolyte layers, and a plurality of positive electrodes; a plurality of positive electrode substrate tabs extending from each of the plurality of positive electrodes of the stack cell; and a plurality of insulating members surrounding and insulating each of the plurality of positive electrode substrate tabs.

### TECHNICAL FIELD

The present disclosure relates to an all-solid rechargeable battery.

### BACKGROUND ART

Recently, as the risk of explosion in batteries using liquid electrolytes has been reported, development of all-solid rechargeable batteries is underway. An all-solid rechargeable battery is a battery in which all materials are solid and uses solid electrolytes. Such an all-solid rechargeable battery is safe because there is no risk of explosion due to electrolyte leakage, and it has the merits of being easy to manufacture as a thin battery, having high energy density, and being able to implement large capacity.

### DISCLOSURE

### Technical Problem

Embodiments are intended to provide an all-solid rechargeable battery that can reduce a defect rate and improve performance by preventing a short between a positive electrode substrate tab and a negative electrode.

### Technical Solution

An all-solid rechargeable battery according to an embodiment includes: a stack cell including a plurality of battery cells that are stacked and include a plurality of negative electrodes, a plurality of solid electrolyte layers, and a plurality of positive electrodes; a plurality of positive electrode substrate tabs extending from each of the plurality of positive electrodes of the stack cell; and a plurality of insulating members surrounding and insulating each of the plurality of positive electrode substrate tabs.

The positive electrode substrate tab may have a tab bending portion that is bent, and the insulating member may be disposed on the tab bending portion.

An edge of the negative electrode may protrude by a protruding portion compared to an edge of the positive electrode, and a portion of the insulating member may be disposed, while overlapping the protruding portion.

A portion of the insulating member may be disposed in a recessed portion surrounded by the edge of the positive electrode and a solid electrolyte layer adjacent to the edge of the positive electrode.

At least a portion of the insulating member may be in contact with the solid electrolyte layer forming the recessed portion.

A width of the insulating member may be greater than a width of the recessed portion.

The all-solid rechargeable battery may further include a positive electrode lead tab to which the plurality of positive electrode substrate tabs are connected together, wherein the positive electrode substrate tab may include a positive electrode tab one end connected to the edge of the positive electrode, a positive electrode tab other end connected to the edge of the positive electrode lead tab, and a positive electrode tab connection portion connecting the positive electrode tab one end and the positive electrode tab other end, and the tab bending portion may be disposed at the positive electrode tab one end.

The all-solid rechargeable battery may further include a plurality of negative electrode substrate tab respectively extending from the plurality of negative electrodes of the stack cell; and a negative electrode lead tab to which the plurality of negative electrode substrate tabs are connected together.

The positive electrode may include a positive electrode current collecting layer and a first positive electrode active material layer and a second positive electrode active material layer disposed on both sides of the positive electrode current collecting layer, and the positive electrode substrate tab may extend from the positive electrode current collecting layer.

The positive electrode substrate tab may include the same material as the positive electrode current collecting layer.

The positive electrode substrate tab may be integrally formed with the positive electrode current collecting layer.

The positive electrode may include a positive electrode current collecting layer and a positive electrode active material layer disposed on one side of the positive electrode current collecting layer, the positive electrode substrate tab may extend from the positive electrode current collecting layer, and a thickness of the positive electrode substrate tab may smaller than a thickness of the positive electrode current collecting layer.

The positive electrode substrate tab may include the same material as the positive electrode current collecting layer.

The stack cell may further include an elastic member disposed between adjacent battery cells.

The insulating member may include an insulation layer coated on the positive electrode substrate tab or an insulating tape surrounding the positive electrode substrate tab.

### Advantageous Effects

According to the embodiments, the insulating member surrounding the positive electrode substrate tab is installed and thus the stack cell can be pressurized to prevent the positive electrode substrate tab from contacting the negative electrode and being shorted even when the thickness of the stack cell changes.

Therefore, the defect rate of the all-solid rechargeable battery can be reduced and the performance can be improved.

### DESCRIPTION OF THE DRAWINGS

FIG. 1 is a cross-sectional view of an all-solid battery.

FIG. 2 is a cross-sectional view of an all-solid battery including a precipitation-type negative electrode.

FIG. 3 is a cross-sectional view of an all-solid rechargeable battery according to an embodiment.

FIG. 4 is a partially enlarged view of the portion A of FIG. 3.

FIG. 5 is a cross-sectional view of an all-solid rechargeable battery according to another embodiment.

FIG. 6 is an enlarged view of the portion B of FIG. 5.

### MODE FOR INVENTION

Hereinafter, embodiments of the present disclosure are described in detail with reference to the accompanying drawing and thus that a person of ordinary skill in the technical field to which the present disclosure belongs can easily practice the present disclosure. As those skilled in the art would realize, the described embodiments may be modified in various different ways, all without departing from the spirit or scope of the present invention.

In addition, unless explicitly described to the contrary, the word “comprise”, and variations such as “comprises” or “comprising”, will be understood to imply the inclusion of stated elements but not the exclusion of any other elements.

In order to clearly express multiple layers and regions in the drawing, the thickness is enlarged, and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” includes not only a shape formed on the entire surface when viewed on a plane, but also a shape formed on some surfaces. Here, “or” is not interpreted in an exclusive sense, for example, “A or B” is interpreted as including A, B, A+B, and the like.

Positive Electrode for all-Solid Rechargeable Battery

In an embodiment, as a positive electrode for an all-solid rechargeable battery, including a current collecting layer and a positive electrode active material layer disposed on the current collecting layer, a positive electrode for an all-solid rechargeable battery of which a positive electrode active material includes at least one of a sulfide-based solid electrolyte, a binder, and a conductive material is provided. However, this is not restrictive, and the positive electrode for the all-solid rechargeable battery may include more or fewer components than the components described above.

In an embodiment, a positive electrode for an all-solid rechargeable battery is manufactured by applying a positive electrode composition including at least one of a positive electrode active material, a sulfide-based solid electrolyte, a binder, and a conductive material to a current collecting layer, followed by drying and rolling.

### Positive Electrode Active Material

The positive electrode active material may be applied without limitation as long as it is generally-used in all-solid rechargeable batteries. For example, the positive electrode active material may be a compound capable of reversible intercalation and deintercalation of lithium, and may include a compound represented by one of the following formulas:

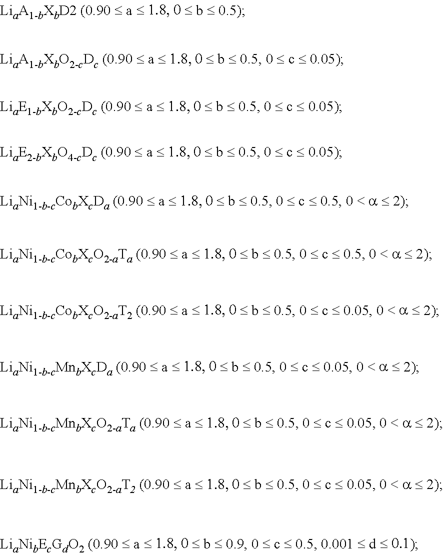

In the above formulas, A is selected from a group consisting of Ni, Co, Mn, and a combination thereof; X is selected from a group consisting of Al, Ni, Co, Mn, Cr, Fe, Mg, Sr, V, a rare-earth element, and a combination thereof; D is selected from a group consisting of O, F, S, P, and a combination thereof; E is selected from a group consisting of Co, Mn, and a combination thereof; T is selected from a group consisting of F, S, P, and a combination thereof; G is selected from a group consisting of Al, Cr, Mn, Fe, Mg, La, Ce, Sr, V, and a combination thereof; Q is selected from a group consisting of Ti, Mo, Mn, and a combination thereof; Z is selected from a group consisting of Cr, V, Fe, Sc, Y, and a combination thereof; and J is selected from a group consisting of V, Cr, Mn, Co, Ni, Cu, and a combination thereof.

The ositive electrode active material may include, for example, lithiumcobaltoxide (LCO), lithiumnickeloxide (LNO), lithiumnickelcobaltoxide (NC), lithiumnickelcobaltaluminumoxide (NCA), lithiumnickelcobaltmanganeseoxide (NCM), lithiumnickelmanganeseoxide (NM), lithiummanganeseoxide (LMO), or lithiumphosphoric acid iron oxide (LFP) and the like.

The positive electrode active material may include a lithium nickel-based oxide represented by the following Chemical Formula 1, a lithium cobalt-based oxide represented by the following Chemical Formula 2, a lithium phosphoric acid iron-based compound represented by the following Chemical Formula 3, or a combination thereof.

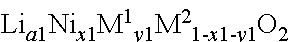

In Chemical Formula 1, 0.9≤a1≤1.8, 0.3≤x1≤1, 0≤y1≤0.7 and, M¹ and M² each independently one or more elements selected from a group consisting of Al, B, Ba, Ca, Ce, Co, Cr, Cu, F, Fe, Mg, Mn, Mo, Nb, P, S, Si, Sr, Ti, V, W, and Zr.

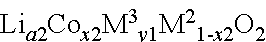

In Chemical Formula 2, 0.9≤a2≤1.8, 0.6≤x2≤1 and, M³ is one or more elements selected from a group consisting of Al, B, Ba, Ca, Ce, Cr, Cu, F, Fe, Mg, Mn, Mo, Nb, P, S, Si, Sr, Ti, V, W, and Zr.

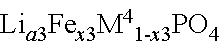

In Chemical Formula 3, 0.9≤a3≤1.8, 0.6≤x3≤1 and, M⁴ is one or more elements selected from a group consisting of Al, B, Ba, Ca, Ce, Co, Cr, Cu, F, Fe, Mg, Mn, Mo, Nb, P, S, Si, Sr, Ti, V, W, and Zr.

An average particle diameter D50 of the positive electrode active material may be 1 μm to 25 μm, for example 3 μm to 25 μm, 5 μm to 25 μm, 5 μm to 20 μm, 8 μm to 20 μm, or 10 μm to 18 μm. The positive electrode active materials having such a particle diameter range may be harmoniously mixed with other components within the positive electrode active material layer and realize high capacity and a high energy density.

The positive electrode active material may be in the form of secondary particles formed by coagulation of a plurality of primary particles, or may be in the form of a single particle. In addition, the positive electrode active material may have a spherical shape or a shape close to a spherical shape, or may be polyhedron or irregularly shaped.

### Sulfide-Based Solid Electrolyte

The sulfide-based solid electrolyte may include, for example, Li₂S—P₂S₅, Li₂S—P₂S⁵—LiX (X is a halogen element, for example 1 or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (m are n are respectively integers, and Z is Ge, Zn, or Ga), Li₂S—GeS₂, Li₂S—SiS₂—Li₃PO₄, Li₂S—SiS₂—LiₚMO_{q} (p and q are integers and M is P, Si, Ge, B, Al, Ga, or In), or a combination thereof.

Such a sulfide-based solid electrolyte may be obtained, for example, by mixing Li₂S and P₂S₅ in a mole ratio of 50:50 to 90:10, or in a mole ratio of 50:50 to 80:20, and selectively heat treating them. In such a mixing ratio range, a sulfide-based solid electrolyte with excellent ionic conductivity can be manufactured. Here, other components such as SiS₂, GeS₂, and B₂S₃ may be added to further improve the ion conductivity.

A mechanical milling or solution method may be applied as a mixing method of sulfur-containing raw materials for manufacturing the sulfide-based solid electrolyte. Mechanical milling is a method of mixing starting materials by placing them in a reactor and vigorously stirring them with a ball mill or similar device to particulate the starting materials. When using the solution method, the starting materials may be mixed in a solvent to obtain a solid electrolyte as a precipitate. In addition, when heat treatment is performed after mixing, the crystals of the solid electrolyte may become more solid and the ion conductivity can be improved. For example, a sulfide-based solid electrolyte may be manufactured by mixing sulfur-containing raw materials and performing heat treatment twice or more, in which case a sulfide-based solid electrolyte with high ion conductivity and robustness can be manufactured.

As an example, the sulfide-based solid electrolyte particle may include an argyrodite-type sulfide. The argyrodite-type sulfide may be represented by a chemical formula of LiₐM_{b}P_{c}S_{d}Aₑ (a, b, c, d, and e are all 0 or more and 12 or less, M is a metal excluding Li or a combination of a plurality of metals excluding Li, and A is F, Cl, Br, or I), and specifically, may be represented by, for example, a chemical formula of Li₇₋ₓPS₆₋ₓAₓ (x is 0.2 or more and 1.8 or less, and A is F, Cl, Br, or I). The argyrodite-type sulfide may be Li₃PS₄, Li₂P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, and the like.

Sulfide-based solid electrolyte particles containing the argyrodite-type sulfide have high ionic conductivities close to the ionic conductivities of typical liquid electrolytes (10⁻⁴ to 10⁻² S/cm range) at room temperature, and may form close bonds between positive electrode active materials and solid electrolytes without causing a decrease in ionic conductivity, and further form close interfaces between the electrode layer and the solid electrolyte layer. An all-solid battery including this may have improved battery performance such as rate characteristic, coulomb efficiency, and life-span characteristic.

An argyrodite-type sulfide-based solid electrolyte may be prepared by mixing, for example, lithium sulfide and selectively halogenated lithium, which is a sulfide. After mixing these, heat treatment may be performed. The heat treatment may include, for example, two or more heat treatment steps.

The average particle diameter D50 of the sulfide-based solid electrolyte particle according to one embodiment may be 5.0 μm or less, and for example, 0.1 μm to 5.0 μm, 0.1 μm to 4.0 μm, 0.1 μm to 3.0 μm, 0.5 μm to 2.0 μm, or 0.1 μm to 1.5 μm. Alternatively, the sulfide-based solid electrolyte particle may be a small particle with an average particle diameter D50 of 0.1 μm to 1.0 μm, or a large particle with an average particle diameter D50 of 1.5 μm to 5.0 μm, depending on the position or purpose used. Sulfide-based solid electrolyte particles of such a particle diameter range can effectively penetrate between solid particles in a battery, and have excellent contact with the electrode active material and connectivity between solid electrolyte particles. The average particle diameter of the sulfide-based solid electrolyte particles may be measured from a microscope image, for example, by measuring the sizes of about 20 particles in a scanning electron microscope image to obtain a particle size distribution and calculating D50 therefrom.

The content of the solid electrolyte in the positive electrode for the all-solid battery may be 0.5 wt % to 35 wt %, for example, 1 wt % to 35 wt %, 5 wt % to 30 wt %, 8 wt % to 25 wt %, or 10 wt % to 20 wt %. This is the content for the total weight of components in the positive electrode, and specifically, it may be the content for the total weight of the positive electrode active material layer.

In one embodiment, the positive electrode active material layer may include 50 wt % to 99.35 wt % of the positive electrode active material, 0.5 wt % to 35 wt % of the sulfide-based solid electrolyte, 0.1 wt % to 10 wt % of a fluorinated resin binder, and 0.05 wt % to 5 wt % of vanadium oxide, based on 100 wt % of the positive electrode active material layer. When such a content range is satisfied, the positive electrode for the all-solid rechargeable battery may achieve high capacity and high ion conductivity while maintaining high adhesive strength, and the viscosity of the positive electrode composition may be maintained at an appropriate level, thereby improving processability.

### Binder

The binder serves to attach the positive electrode active material particles well to each other and also to the current collector. Representative examples of the binder include polyvinylalcohol, carboxylmethylcellulose, hydroxypropylcellulose, diacetylcellulose, polyvinylchloride, carboxylated polyvinylchloride, polyvinylfluoride, polymers containing ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, nylon, and the like, but is not limited thereto.

### Conductive Material

The positive electrode active material layer may further include a conductive material. The conductive material is used to provide conductivity to the electrode, and may include, for example, a carbon-based material such as natural graphite, artificial graphite, carbon black, acetylene black, Ketjenblack, carbon fiber, and carbonnanotube; a metal-based material in the form of metal powder or metal fiber, such as copper, nickel, aluminum, and silver; a conductive polymer such as polyphenylene derivatives; or a mixture thereof.

The conductive material may be included in an amount of 0.1 wt % to 5 wt %, or 0.1 wt % to 3 wt %, relative to the total weight of each component of the positive electrode for the all-solid battery, or relative to the total weight of the positive electrode active material layer. In such a content range, the conductive material can improve electrical conductivity without deteriorating battery performance.

When the positive electrode active material layer further includes the conductive material, the positive electrode active material layer may include 45 wt % to 99.25 wt % of the positive electrode active material, 0.5 wt % to 35 wt % of the sulfide-based solid electrolyte, 0.1 wt % to 10 wt % of the fluorinated resin binder, 0.05 wt % to 5 wt % of vanadium oxide, and 0.1 wt % to 5 wt % of the conductive material, with respect to 100 wt % of the positive electrode active material layer.

Meanwhile, the positive electrode for the lithium rechargeable battery may further include an oxide-based inorganic solid electrolyte in addition to the aforementioned solid electrolyte. The oxide-based inorganic solid electrolyte may include, for example, Li₁₊ₓTi₂₋ₓAl PO₄₃(LTAP) (0≤x≤4), Li_{1+x+y}AlₓTi₂₋ₓSi_{y}P_{3-y}O₁₂ (0<x<2, 0≤y<3), BaTiO₃, Pb(Zr, Ti)O₃(PZT), Pb₁₋ₓLaₓZr_{1-y}Ti_{y}O₃(PLZT) (0≤x<1, 0≤y<1), PB(Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}PO₄₃, 0<x<2, 0<y<3), Li_{1+x+y}(Al, Ga)ₓ(Ti, Ge)₂₋ₓSi_{y}P_{3-y}O₁₂(0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, garnet-based ceramics Li₃₊ₓLa₃M₂O₁₂ (M=Te, Nb, or Zr; x is an integer of 1 to 10), or a combination thereof.

### All-Solid Rechargeable Battery

In one embodiment, an all-solid rechargeable battery including the aforementioned positive electrode, negative electrode, and solid electrolyte layer disposed between the positive electrode and the negative electrode is provided. The all-solid rechargeable battery may also be expressed as an all-solid battery, or an all-solid lithium rechargeable battery.

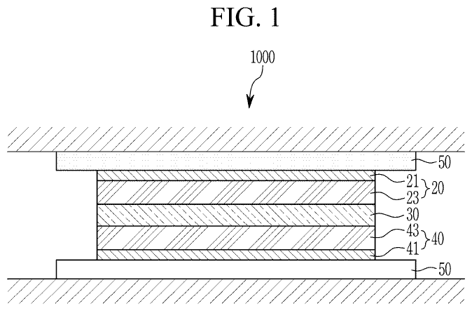

FIG. 1 is a cross-sectional view of an all-solid battery.

Referring to FIG. 1, an all-solid battery 1000 may have a structure in which an electrode assembly formed by stacking a negative electrode 40 including a negative electrode current collecting layer 41 and a negative electrode active material layer 43, a solid electrolyte layer 30, and a positive electrode 20 including a positive electrode active material layer 23 and a positive electrode current collecting layer 21 is accommodated in a case such as a pouch. The all-solid battery 1000 may further include an elasticity layer 50 on the outside of at least one of the positive electrode 20 and the negative electrode 40. FIG. 1 illustrates one electrode assembly including the negative electrode 40, the solid electrolyte layer 30, and the positive electrode 20, but the all-solid battery may be manufactured by stacking two or more electrode assemblies.

### Negative Electrode

The negative electrode for the all-solid battery may include, for example, a current collecting layer and a negative electrode active material layer disposed on the current collecting layer. The negative electrode active material layer includes the negative electrode active material and may further include a binder, a conductive material, and/or a solid electrolyte.

The negative electrode active material may include a material capable of reversibly intercalating/deintercalating lithium ions, a lithium metal, an alloy of lithium metal, a material capable of doping and dedoping lithium, or a transition metal oxide.

A material capable of reversibly intercalating/deintercalating lithium ions includes a carbon-based negative electrode active material, such as crystalline carbon, amorphous carbon, or a combination thereof. Examples of crystalline carbon include graphite such as natural graphite or artificial graphite in amorphous, plate-like, flake-like, spherical shape or fiber shape, and examples of amorphous carbon include soft carbon or hard carbon, mesophase pitch carbide, and calcined coke.

As an alloy of lithium metal, an alloy of lithium and one or more metals selected from Na, K, Rb, Cs, Fr, Be, Mg, Ca, Sr, Si, Sb, Pb, In, Zn, Ba, Ra, Ge, Al, and Sn may be used.

As a material that can be doped and dedoped into lithium, an Si-based negative electrode active material or an Sn-based negative electrode active material may be used. Silicon, a silicon-carbon composite, SiOₓ (0<x<2), or an Si-Q alloy (Q is an element selected from a group consisting of alkali metal, alkaline-earth metal, a group 13 element, a group 14 element, a group 15 element, a group 16 element, a transition metal, a rare-earth element and a combination thereof, but not Si) may be used as the Si-based negative electrode active material, and Sn, SnO₂, an Sn—R alloy (R is an element selected from a group consisting of an alkali metal, an alkaline-earth metal, a group 13 element, a group 14 element, a group 15 element, a group 16 element, a transition metal, a rare-earth element, and a combination thereof, but not Sn) may be used as the Sn-based negative electrode active material, and additionally, at least one of these may be mixed with SiO₂. Elements Q and R may be selected from a group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

A silicon-carbon composite may be, for example, a silicon-carbon composite including a core including crystalline carbon and silicon particles and an amorphous carbon coating layer positioned on the surface of the core. Crystalline carbon may be artificial graphite, natural graphite or a combination thereof. As amorphous carbon precursors, coal pitch, mesophase pitch, petroleum pitch, coal-based oil, petroleum-based heavy oil, or polymer resins such as phenol resin, furan resin, and polyimide resin may be used. In this case, the silicon content may be 10 wt % to 50 wt % with respect to the entire weight of the silicon-carbon composite. In addition, the content of crystalline carbon may be 10 wt % to 70 wt % with respect to the entire weight of the silicon-carbon composite, and the content of amorphous carbon can be 20 wt % to 40 wt % with respect to the entire weight of the silicon-carbon composite. In addition, a thickness of the amorphous carbon coating layer may be 5 nm to 100 nm.

The average particle diameter D50 of silicon particles may be from 10 nm to 20 μm, for example from 10 nm to 500 nm. The silicon particles may exist in an oxidized form, and in this case, the atom content ratio of Si:O in the silicon particles, which indicates the degree of oxidation, may be from 99:1 to 33:67. A silicon particle may be a SiOₓ particle, where the x range in SiOₓ may be greater than 0 and less than 2. Here, the average particle diameter D50 is measured by a particle size analyzer using a laser diffraction method, and refers to the diameter of particles with a cumulative volume of 50 volume % in the particle size distribution.

An Si-based negative electrode active material or an Sn-based negative electrode active material may be used in combination with a carbon-based negative electrode active material. Si-based negative electrode active material or Sn-based negative electrode active material; the mixing ratio of the and carbon-based negative electrode active material may be 1:99 to 90:10 in weight ratio.

The content of the negative electrode active material in the negative electrode active material layer may be 95 wt % to 99 wt % with respect to the entire weight of the negative electrode active material layer.

In one embodiment, the negative electrode active material layer further includes a binder and may further include a selectively conductive material. The content of the binder in the negative electrode active material layer may be 1 wt % to 5 wt % with respect to the entire weight of the negative electrode active material layer. In addition, when further including the conductive material, the negative electrode active material layer may include 90 wt % to 98 wt % of the negative electrode active material, 1 wt % to 5 wt % of the binder, and 1 wt % to 5 wt % of the conductive material.

The binder serves to attach the negative electrode active material particles well to each other and also to attach the negative electrode active material well to the current collecting layer. The binder may include a non-water-soluble binder, a water-soluble binder or a combination thereof.

The non-water-soluble binders may include, for example, polyvinylchloride, carboxylated polyvinylchloride, polyvinylfluoride, polymers containing ethylene oxide, ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

An example of a water-soluble binder may include a rubber binder or a polymer resin binder. The rubber binder may be selected from styrene-butadiene rubber, acrylated styrene-butadiene rubber, acrylonitrile-butadiene rubber, acryl rubber, butyl rubber, fluorinated rubber, and a combination thereof. The polymer resin binder may be selected from polyethyleneoxide, polyvinylpyrrolidone, polyepichlorohydrine, polyphosphazene, polyacrylonitrile, ethylenepropylenediene copolymer, polyvinylpyridine, chlorosulfonated polyethylene, latex, polyester resin, acryl resin, phenol resin, epoxy resin, polyvinylalcohol and a combination thereof.

When a water-soluble binder is used as the negative electrode binder, a thickener capable of providing viscosity may be used together, and the thickener may include, for example, a cellulose-based compound. The cellulose-based compound may include carboxylmethyl cellulose, hydroxypropylmethyl cellulose, methyl cellulose, an alkali metal salt thereof, or a combination thereof. Na, K, or Li may be used as the alkali metal. The amount of such thickener used may be from 0.1 parts by weight to 3 parts by weight with respect to 100 parts by weight of the negative electrode active material.

The conductive material is used to provide conductivity to the electrode, and may include, for example, a carbon-based material such as natural graphite, artificial graphite, carbon black, acetylene black, Ketjenblack, carbon fiber, and carbonnanotube; a metal-based material in the form of metal powder or metal fiber, such as copper, nickel, aluminum, and silver; a conductive polymer such as polyphenylene derivatives; or a mixture thereof.

The negative electrode current collecting layer may be selected from copper foil, nickel foil, stainless steel foil, titanium foil, nickel foam, copper foam, a polymer substrate coated with a conductive metal, and a combination thereof. As another example, the negative electrode for the all-solid battery may be a precipitation-type negative electrode. The precipitation-type negative electrode refers to a negative electrode that does not contain a negative electrode active material when the battery is assembled, but in which lithium metal and the like is precipitated when the battery is charged and this acts as the negative electrode active material.

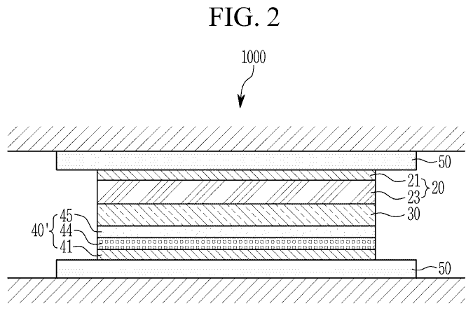

FIG. 2 is a cross-sectional view of an all-solid battery including a precipitation-type negative electrode.

Referring to FIG. 2, a precipitation-type negative electrode 40′ may include a current collecting layer 41 and a negative electrode coating layer 45 disposed on the current collecting layer 41. In an all-solid battery having such a precipitation-type negative electrode 40′, initial charging begins in the absence of a negative electrode active material, and during charging, a high-density lithium metal is precipitated between the current collecting layer 41 and the negative electrode coating layer 45 to form a lithium metal layer 44, which serves as the negative electrode active material. Accordingly, in the all-solid battery that has been charged more than once, the precipitation-type negative electrode 40′ may include a current collecting layer 41, a lithium metal layer 44 positioned on the current collecting layer 41, and a negative electrode coating layer 45 disposed on the metal layer 44. The lithium metal layer 44 refers to a layer in which lithium metal and the like is precipitated during the charging process of the battery, and may be referred to as a metal layer or negative electrode active material layer.

The negative electrode coating layer 45 may include a metal, a carbon material, or a combination thereof that serves as a catalyst.

The metal may include, for example, gold, platinum, palladium, silicon, silver, aluminum, bismuth, tin, zinc, or a combination thereof, and may be composed of one of these or of an alloy of several types. When the metal exists in particle form, the average particle diameter D50 of the particles may be less than about 4 μm, for example, 10 nm to 4 μm.

The carbon material may be, for example, crystalline carbon, amorphous carbon, or a combination thereof. The crystalline carbon may be, for example, natural graphite, artificial graphite, mesophase carbon microbeads, or a combination thereof. Amorphous carbon may be, for example, carbon black, activated carbon, acetylene black, Denka black, Ketjen black, or a combination thereof.

When the negative electrode coating layer 45 includes both metal and carbon material, the mixing ratio of the metal and the carbon material may be, for example, a weight ratio of 1:10 to 2:1. In this case, the precipitation of lithium metal can be effectively promoted and the characteristics of the all-solid battery can be improved. The negative electrode coating layer 45 may include, for example, a carbon material supported with a catalyst metal, or may include a mixture of metal particles and carbon material particles.

The negative electrode coating layer 45 may include, for example, metal and amorphous carbon, in which case it may effectively promote the precipitation of lithium metal.

The negative electrode coating layer 45 may further include a binder, and the binder may be a conductive binder. In addition, the negative electrode coating layer 45 may further include a general additive such as a filler, a dispersant, and an ion conductive agent.

A thickness of the negative electrode coating layer 45 may be, for example, 100 nm to 20 μm, or 500 nm to 10 μm, or 1 μm to 5 μm.

The precipitation-type negative electrode 40′ may further include a thin film on a surface of the current collecting layer 41, that is, for example, between the current collecting layer 41 and the negative electrode coating layer 45. The thin film may contain elements that can form an alloy with lithium. Elements that can form alloys with lithium include, for example, gold, silver, zinc, tin, indium, silicon, aluminum, bismuth, and the like, and the alloy may be composed of one of these or of several types. The thin film may further planarize the precipitation pattern of the lithium metal layer 44 and further improve the characteristics of the all-solid battery. The thin film may be formed by methods such as vacuum deposition, sputtering, and plating. A thickness of the thin film may be, for example, 1 nm to 500 nm.

### Solid Electrolyte Layer

The solid electrolyte layer 30 may include a sulfide-based solid electrolyte, an oxide-based solid electrolyte, and the like. The specific details of the sulfide-based solid electrolyte and the oxide-based solid electrolyte are as described above.

In one embodiment, the solid electrolyte included in the positive electrode 20 and the solid electrolyte included in the solid electrolyte layer 30 may include the same compound or different compounds. For example, when both the positive electrode 20 and the solid electrolyte layer 30 contain argyrodite-type sulfide solid electrolytes, the overall performance of the all-solid rechargeable battery can be improved. In addition, as an example, when both the positive electrode 20 and the solid electrolyte layer 30 include the aforementioned coated solid electrolyte, the all-solid rechargeable battery may implement high capacity, a high energy density, and excellent initial efficiency, and life-span characteristics.

Meanwhile, the average particle diameter D50 of the solid electrolyte included in the positive electrode 20 may be smaller than the average particle diameter D50 of the solid electrolyte included in the solid electrolyte layer 30. In this case, the energy density of the all-solid battery may be maximized while increasing the mobility of lithium ions, thereby improving the overall performance. For example, the average particle diameter D50 of the solid electrolyte included in the positive electrode 20 may be 0.1 μm to 1.0 μm, or 0.1 μm to 0.8 μm, and the average particle diameter D50 of the solid electrolyte included in the solid electrolyte layer 30 may be 1.5 μm to 5.0 μm, or 2.0 μm to 4.0 μm, or 2.5 μm to 3.5 μm. When such a particle diameter range is satisfied, the energy density of the all-solid rechargeable battery can be maximized, while the transfer of lithium ions is facilitated, thus suppressing resistance and improving the overall performance of the all-solid rechargeable battery. Here, the average particle diameter D50 of the solid electrolyte may be measured using a particle size analyzer using the laser diffraction method. Alternatively, 20 random particles may be selected from a microscope image, such as a scanning electron microscope image, and particle sizes are measured and a particle size distribution is obtained to calculate the D50 value therefrom.

The solid electrolyte layer may further include a binder in addition to the solid electrolyte. In this case, styrene butadiene rubber, polytetrafluoroethylene, polyvinylidene fluoride, polyethylene, an acrylate polymer, or a combination thereof may be used as a binder, but is not limited thereto, and any binder used in the relevant technical field may be used. The acrylate polymer may be, for example, butyl acrylate, polyacrylate, polymethacrylate, or a combination thereof.

A solid electrolyte layer may be formed by adding a solid electrolyte to a binder solution, coating it on a substrate film, and drying it. A solvent of the binder solution may be isobutyryl isobutylate, xylene, toluene, benzene, hexane, or a combination thereof. The solid electrolyte layer forming process is widely known in the field, and therefore a detailed description will be omitted.

A thickness of the solid electrolyte layer may be, for example, 10 μm to 150 μm.

The solid electrolyte layer may further include an alkali metal salt, and/or an ionic liquid, and/or a conductive polymer.

The alkali metal salt can be, for example, lithium salt. The lithium salt content in the solid electrolyte layer may be greater than 1 M, and for example, 1 M to 4 M. In this case, lithium salt may improve ion conductivity by enhancing lithium ion mobility of the solid electrolyte layer.

Lithium salt may include, for example, LiSCN, LIN (CN)₂, Li(CF₃SO₂)₃C, LiC₄F₉SO₃, LiN(SO₂CF₂CF₃)₂, LiCl, LiF, LiBr, LiI, LiB C₂O₄₂, LiBF₄, LiBF₃ C₂F₅, lithium bis(oxalato) borate, (LiBOB), lithium oxalyldifluoroborate (LIODFB), lithium difluoro (oxalato) borate (LiDFOB), lithium bis(trifluoro methanesulfonyl)imide, LiTFSI, LiN(SO₂CF₃)₂), lithium bis(fluorosulfonyl)imide, LIFSI, LiN(SO₂F)₂), LiCF₃SO₃, LiAsF₆, LiSbF₆, LiClO₄, or a mixture thereof.

In addition, lithium salt may be an imide, for example, the imide lithium salt may include lithium bis(trifluoro methanesulfonyl)imide, LiTFSI, LiN (SO₂CF₃)₂), and lithium bis(fluorosulfonyl)imide, LiFSI, LiN(SO₂F)₂). Lithium salt may maintain or improve ionic conductivity by maintaining appropriate chemical reactivity with ionic liquid.

The ionic liquid is a salt or room temperature fusion salt that is composed only of ions and is in a liquid state at room temperature, with a melting point below room temperature.

The ionic liquid may be a compound including one or more positive ions selected from a) ammonium-based, pyrroleidinium-based, pyridinium-based, pyrimidinium-based, imidazoleium-based, piperidinium-based, pyrazoleium-based, oxazoleium-based, pyridazinium-based, phosphonium-based, sulfonium-based, triazoleium-based, and a mixtures thereof; and b) one or more types of negative ions selected from BF₄₋, PF₆₋, AsF₆₋, SbF₆₋, AlCl₄₋, HSO₄₋, ClO₄₋, CH₃SO₃₋, CF₃CO₂₋, Cl—, Br—, I—, BF₄₋, SO₄₋, CF₃SO₃₋, FSO₂₂N—, (C₂F₅SO₂)₂N—, (C₂F₅SO₂, CF₃SO₂)N—, and (CF₃SO₂)₂N—.

The ionic liquid may be, for example, at least one selected from a group consisting of N-methyl-N-propylpyrroledinium bis(trifluoromethanesulfonyl)imide, N-butyl-N-methylpyrroledinium bis(3-trifluoromethylsulfonyl)imide, 1-butyl-3-methylimidazolelium bis(trifluoromethylsulfonyl)amide, and 1-ethyl-3-methylimidazolelium bis(trifluoromethylsulfonyl)amide.

The weight ratio of the solid electrolyte to the ionic liquid in the solid electrolyte layer may be 0.1:99.9 to 90:10, for example, 10:90 to 90:10, 20:80 to 90:10, 30:70 to 90:10, 40:60 to 90:10, or 50:50 to 90:10. A solid electrolyte layer satisfying the range may maintain or improve ion conductivity by improving the electrochemical contact area with the electrode. Accordingly, the energy density, discharge capacity, and rate characteristics of the all-solid battery can be improved.

The all-solid battery may be a unit battery having a structure of positive electrode/solid electrode layer/negative electrode, a bi-cell having a structure of positive electrode/solid electrode layer/negative electrode/solid electrode layer/positive electrode, or a laminated battery in which the structure of the unit battery is repeated.

The shape of the all-solid battery is not particularly limited, and may be, for example, coin-type, button-type, sheet-type, laminated, cylindrical, equilibrium, and the like. In addition, the all-solid battery may be applied to a large-scaled battery used in an electric vehicle and the like. For example, all-solid battery may be used in a hybrid vehicle such as a plug-in hybrid electric vehicle (PHEV). In addition, it may be used in fields that require large amounts of electric power storage, for example, electric bicycles or electric tools.

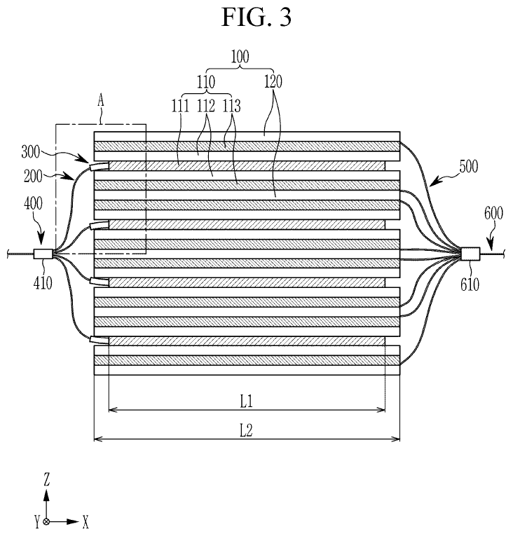

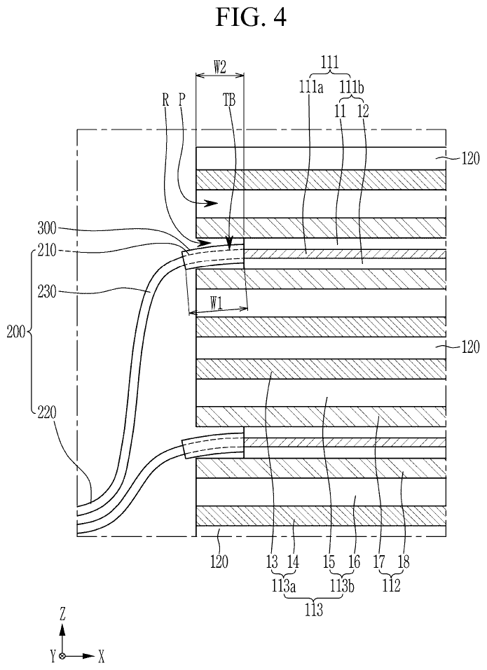

Hereinafter, an all-solid rechargeable battery according to an embodiment will be described with reference to FIG. 3 and FIG. 4.

FIG. 3 is a cross-sectional view of an all-solid rechargeable battery according to an embodiment, and FIG. 4 is a partially enlarged view of the portion A of FIG. 3.

As shown in FIG. 3 and FIG. 4, an all-solid rechargeable battery according to an embodiment is a rechargeable battery that is capable of being repeatedly charged and discharged, and includes a stack cell 100, a plurality of positive electrode substrate tabs 200, a plurality of insulating members 300, a plurality of positive electrode lead tabs 400, a plurality of negative electrode substrate tabs 500, and a plurality of negative electrode lead tabs 600.

The stack cell 100 may include a plurality of battery cell 110 and a plurality of elastic members 120.

The plurality of battery cells 110 may be stacked. One battery cell 110 may include a positive electrode 111, a solid electrolyte layer 112, and a negative electrode 113. Here, the positive electrode 11 may include a cathode, and the negative electrode 113 may include an anode.

The positive electrode 111 may include a positive electrode current collecting layer 111a, and a positive electrode active material layer 111b disposed on both sides of the positive electrode current collecting layer 111a. The positive electrode active material layer 111b may include a first positive electrode active material layer 11 and a second positive electrode active material layer 12.

The positive electrode current collecting layer 111a may have a plate shape or a foil shape. The positive electrode current collecting layer 111a may include any one selected from aluminum (Al), indium (In), copper (Cu), magnesium (Mg), stainless steel (SUS), titanium (Ti), iron (Fe), cobalt (Co), nickel (Ni), zinc (Zn), germanium (Ge), and lithium (Li).

The positive electrode active material layer 111b may be formed by coating on both sides of the positive electrode current collecting layer 111a. However, it is not limited thereto and may be formed using various methods such as transcription. The positive electrode active material layer 111b may include any one selected from lithium salts such as nickel cobalt manganese lithium (NCM), lithium cobalt oxide (LCO), lithium nickel acid (lithium nickel oxide), lithium nickel cobalt oxide, nickel cobalt aluminum lithium (NCA), lithium manganate, and lithium iron phosphate, sulfide nickel, sulfide copper, sulfide lithium sulfur, iron oxide, or vanadium oxide. The positive electrode 111 may have ductility.

The negative electrode 113 may include a negative electrode current collecting layer 113a, and a negative electrode coating layer 113b disposed on one side of the negative electrode current collecting layer 113a. The negative electrode current collecting layer 113a may include a first negative electrode current collecting layer 13 and a second negative electrode current collecting layer 14 that are respectively disposed on both sides with the positive electrode as a reference. The negative electrode coating layer 113b may include a first negative electrode coating layer 15 and a second negative electrode coating layer 16 disposed on both sides with the positive electrode 111 as a reference. The negative electrode coating layer 113b may be disposed on one side of the negative electrode current collecting layer 113a facing the solid electrolyte layer 112. That is, the negative electrode coating layer 113b may be disposed between the negative electrode current collecting layer 113a and the solid electrolyte layer 112. Specifically, the first negative electrode coating layer 15 may be disposed between the solid electrolyte layer 112 and the first negative electrode current collecting layer 13, and the second negative electrode coating layer 16 may be disposed between the solid electrolyte layer 112 and the second negative electrode current collecting layer 14.

The negative electrode current collecting layer 113a may have a plate shape or a foil shape. The negative electrode current collecting layer 113a may include various known metals and compounds that do not react with lithium. The negative electrode current collecting layer 113a may include any one selected from stainless steel (SUS), copper (Cu), titanium (Ti), iron (Fe), cobalt (Co), and nickel (Ni).

The negative electrode coating layer 113b may include, but is not limited to, silver (Ag) and carbon (C). For example, the negative electrode coating layer 113b may have a structure in which a metal including at least one of gold (Au), platinum (Pt), palladium (Pd), silicon (Si), silver (Ag), aluminum (AI), bismuth (Bi), tin (Sn), and zinc (Zn) or particles formed of a semiconductor are contained in a carbon layer including at least one of carbon black (CB), furnace black (FB), acetylene black (AB), Ketjen black (KB), and graphene. When the all-solid rechargeable battery is charged, lithium is deposited between the negative electrode current collecting layer 113a and the negative electrode coating layer 113b, and a lithium metal layer is formed between the negative electrode current collecting layer 113a and the negative electrode coating layer 113b. After the all-solid rechargeable battery is discharged, lithium precipitated between the negative electrode current collecting layer 113a and the negative electrode coating layer 113b is removed such that the negative electrode current collecting layer 113a and the negative electrode coating layer 113b may directly contact each other.

A maximum length L1 of the positive electrode 111 may be shorter than a maximum length L2 of the negative electrode 113 or solid electrolyte layer 112. Therefore, an N/P ratio, which is a value obtained by dividing the capacity of the positive electrode by the capacity of the negative electrode, may be greater than 1. Here, the length is defined as a length that sets the X-axis direction as a reference.

Therefore, an edge of the negative electrode 113 may be protruded by a protruding portion P relative to an edge of the positive electrode 111, and the positive electrode 111 is indented relative to the adjacent negative electrode 113 such that a recessed portion R may be formed on the outside of the edge of the positive electrode 111 along the X-axis direction. The recessed portion R may be surrounded by the edge of the positive electrode 111 and the solid electrolyte layer 112 adjacent to the edge of the positive electrode 111.

The solid electrolyte layer 112 may be disposed between the positive electrode 111 and the negative electrode 113. That is, the solid electrolyte layer 112 may be disposed between the positive electrode active material layer 111b and the negative electrode coating layer 113b. The solid electrolyte layer 112 may include a first solid electrolyte layer 17 disposed between the first positive electrode active material layer 11 and the first negative electrode coating layer 15, and a second solid electrolyte layer 18 disposed between the second positive electrode active material layer 12 and the second negative electrode coating layer 16.

The solid electrolyte layer 112 may include, but is not limited to, various known sulfide-based solid electrolyte materials. For example, the solid electrolyte layer 112 may include Li2S—P2S5, Li2S—P2S5-LiX (X is a halogen element, for example, I, Cl), Li2S—P2S5-Li2O, Li2S—P2S5-Li2O—LiI, Li2S—SiS2, Li2S—SiS2-LiI, Li2S—SiS2-LiBr, Li2S—SiS2-LiCl, Li2S—SiS2-B2S3-LiI, Li2S—SiS2-P2S5-LiI, Li2S—B2S3, Li2S—P2S5-ZmSn (m and n are positive numbers, and Z is one of Ge, Zn, or Ga), Li2S-GeS2, Li2S—SiS2-Li3PO4, Li2S—SiS2-LipMOq (p and q are positive numbers, and M is one of P, Si, Ge, B, Al, Ga, and In), and the like. The solid electrolyte layer 112 may contain at least one of amorphous and crystalline.

In the present embodiment, with the positive electrode current collecting layer 111a as a reference, a battery cell 110 in which the first positive electrode active material layer 11, the first solid electrolyte layer 17, the first negative electrode coating layer 15, and the first negative electrode current collecting layer 13 are sequentially stacked on the positive electrode current collecting layer 111a, and the second positive electrode active material layer 12, the second solid electrolyte layer 18, the second negative electrode coating layer 16, and the second negative electrode current collecting layer 14 are sequentially disposed below the positive electrode current collecting layer 111a is illustrated. The battery cell 110 having such a stacking structure is called a battery cell of a bi-cell structure. Here, the position relationships above and below is set with the Z-axis direction as reference.

Meanwhile, the elastic member 120 may be disposed between adjacent battery cells 110 or disposed on the outside of the battery cell 110, which is positioned at the outermost position.

A plurality of positive electrode substrate tabs 200 extending from the plurality of positive electrodes 111 of the stack cell 100 are bent and electrically connected by welding to the positive electrode lead tab 400. In addition, in order to operate the stack cell 100 of the all-solid rechargeable battery and secure the performance of the stack cell 100, the stack cell 100 must be pressurized. When the stack cell 100 is pressurized, a thickness of elastic member 120 decreases, and thus the entire thickness of the stack cell 100 also decreases.

In addition, when charging and discharging the stack cell 100, lithium is precipitated and restored at the negative electrode 113 and pressurized, and thus the thickness of the stack cell 100 shrinks or expands. In this case, since the positive electrode substrate tab 200 connected to the positive electrode 111 of the stack cell 100 has a flexible material, the shape of the positive electrode substrate tab 200 also changes, such as being bent. As described, the positive electrode substrate tab 200, which has changed shape, such as being bent, may come into contact with the negative electrode 113, resulting in a short.

However, in the present embodiment, the stack cell 100 can be pressurized by installing an insulating member 300 surrounding the positive electrode substrate tab 200, thereby preventing the positive electrode substrate tab 200 from coming into contact with the negative electrode 113 and causing a short even if the thickness of the stack cell 100 changes. Hereinafter, this will be described in detail.

The plurality of positive electrode substrate tab 200 each may extend from the positive electrode current collecting layer 111a of the plurality of positive electrodes 111. The positive electrode substrate tab 200 may be formed of the same material as the positive electrode current collecting layer 111a of the positive electrode 111 and may be integrally formed with the positive electrode current collecting layer 111a.

The positive electrode substrate tab 200 may include a positive electrode tab one end 210 connected to an edge of the positive electrode 111, a positive electrode tab other end 220 connected to the positive electrode lead tab 400, and a positive electrode tab connection portion 230 connecting the positive electrode tab one end 210 and the positive electrode tab other end 220. The positive electrode tab one end 210, the positive electrode tab other end 220, and the positive electrode tab connection portion 230 may be integrally formed of the same material.

The positive electrode substrate tab 200 may have a tab bending portion TB that is bent. The tab bending portion TB may be disposed at the positive electrode tab one end 210.

The plurality of insulating members 300 may surround the plurality of positive electrode substrate tabs 200 while insulating each of the plurality of positive electrode substrate tabs 200. The insulating member 300 may be disposed on the tab bending portion TB.

A portion of the insulating member 300 may be disposed to overlap the protruding portion P of the negative electrode 113. Therefore, a part of the insulating member 300 may be disposed in the recessed portion R. In addition, at least a portion of the insulating member 300 may be in contact with the solid electrolyte layer 112 forming the recessed portion R.

The insulating member 300 surrounds and insulates the positive electrode substrate tab 200, thereby preventing the tab bending portion TB of the bent positive electrode substrate tab 200 from contacting the negative electrode 113. Therefore, a short between the positive electrode substrate tab 200 and the negative electrode 113 can be prevented.

The insulating member 300 may be formed by coating an insulation layer surrounding the positive electrode substrate tab 200, or by using an insulating tape surrounding the positive electrode substrate tab 200. The insulation layer or insulation tape may have a shape in which a polymer or a composite of polymer and ceramic is coated on a non-woven fabric (NWF). The non-woven fabric may include any one selected from polyester, polypropylene, and polyethylene, and the polymer may be any one selected from polyacrylate, polyvinylidene fluoride-hexafluoropropylene (PVdF-HFP), and hydrogenated nitrile butadiene rubber (H-NBR).

A width W1 of the insulating member 300 may be greater than a width W2 of the recessed portion R. Therefore, a portion of the positive electrode substrate tab 200 that is not covered by the insulating member 300 can be prevented from contacting the solid electrolyte layer 112 forming the recessed portion R.

The positive electrode lead tab 400 may connect the plurality of positive electrode substrate tabs 200 together using the positive electrode connecting member 410.

Thus, even if the thickness of the stack cell 100 including the battery cell 110 of a bi-cell structure changes and the positive electrode substrate tab 200 is severely bent during a process of pressurizing the stack cell 100, the positive electrode substrate tab 200 can be prevented from coming into contact with the negative electrode 113 and a short can be prevented from occurring by installing the insulating member 300 surrounding a portion of the positive electrode substrate tab 200 in the stack cell 100. Therefore, the defect rate of the all-solid rechargeable battery can be reduced and the performance can be improved.

Meanwhile, the plurality of negative electrode substrate tab 500 each may extend from the negative electrode current collecting layer 113a of the plurality of negative electrode 113. The negative electrode substrate tab 500 is formed of the same material as the negative electrode 113 and may be integrally formed with the negative electrode 113. In addition, the negative electrode lead tab 600 may connect the plurality of negative electrode substrate tabs 600 together using the negative electrode connecting member 610.

Meanwhile, in the embodiment, the battery cells forming the stack cell have a bi-cell structure, but another embodiment including a battery cell having a mono-cell structure is also possible.

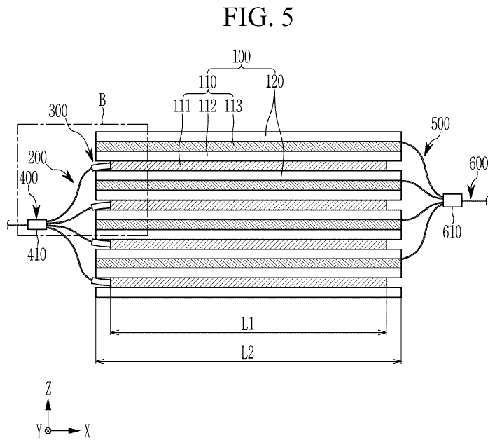

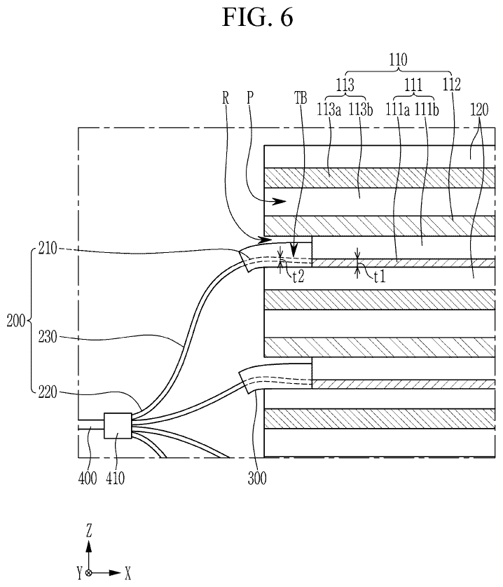

Hereinafter, referring to FIG. 5 and FIG. 6, an all-solid rechargeable battery according to another embodiment will be described in detail.

FIG. 5 is a cross-sectional view of an all-solid rechargeable battery according to another embodiment, and FIG. 6 is an enlarged view of the portion B of FIG. 5.

Another embodiment illustrated in FIG. 5 and FIG. 6 is substantially the same as an embodiment illustrated in FIG. 3 and FIG. 4 except for the structure of the battery cell, and therefore a repeated description is omitted.

As shown in FIG. 5 and FIG. 6, an all-solid rechargeable battery according to another embodiment includes a stack cell 100, a plurality of positive electrode substrate tabs 200, a plurality of insulating members 300, a positive electrode lead tab 400, a plurality of negative electrode substrate tabs 500, and a negative electrode lead tab 600.

The stack cell 100 may include a plurality of battery cells 110 and a plurality of elastic members 120. One battery cell 110 may include a positive electrode 111, a solid electrolyte layer 112, and a negative electrode 113. The positive electrode 111 may include a positive electrode current collecting layer 111a, and a positive electrode active material layer 111b disposed on one side of the positive electrode current collecting layer 111a. The negative electrode 113 may include a negative electrode current collecting layer 113a, and a negative electrode coating layer 113b disposed on one side of the negative electrode current collecting layer 113a. The solid electrolyte layer 112 may be disposed between the positive electrode active material layer 111b and the negative electrode coating layer 113b.

In the present embodiment, a battery cell 110 in which the positive electrode active material layer 111b, the solid electrolyte layer 112, the negative electrode coating layer 113b, and the negative electrode current collecting layer 113a are sequentially stacked on the positive electrode current collecting layer 111a is illustrated. The battery cell 110 having such a stacking structure is called a battery cell of a mono-cell structure.

The plurality of positive electrode substrate tabs 200 may extend from the positive electrode current collecting layers 111a of the plurality of positive electrodes 111, respectively. In this case, a thickness t2 of the positive electrode substrate tab 200 may be smaller than a thickness t1 of the positive electrode current collecting layer 111a.

The positive electrode substrate tab 200 may have a bendable tab bending portion TB. The tab bending portion TB may be disposed on one end 210 of the positive electrode substrate tab.

The plurality of insulating members 300 may insulate each of the plurality of positive electrode substrate tabs 200 while surrounding the same. Such an insulating member 300 may be disposed in the tab bending portion TB.

A portion of the insulating member 300 may be disposed to overlap a protruding portion P of the negative electrode 113. Therefore, a part of the insulating member 300 may be disposed in a recessed portion R.

The insulating member 300 surrounds and insulates the positive electrode substrate tab 200, thereby preventing the tab bending portion TB of the bent positive electrode substrate tab 200 from contacting the negative electrode 113. Therefore, short circuit between positive electrode substrate tab 200 and negative electrode 113 can be prevented.

In this way, the positive electrode substrate tab 200 can be prevented from coming into contact with the negative electrode 113 and being short-circuited even when the thickness of the stack cell 100 changes and the positive electrode substrate tab 200 is severely bent in a process of pressurizing the stack cell 100 by installing an insulating member 300 surrounding a portion of the positive electrode substrate tab 200 in the stack cell 100 including the battery cell 110 of the mono-cell structure. Accordingly, the defect rate of the all-solid rechargeable battery can be reduced and its performance can be improved.

Although the embodiments of the present disclosure have been described in detail above, the scope of the present disclosure is not limited thereto, and various modifications and improvements made by a person of an ordinary skill in the art using the basic concept of the present disclosure defined in the following claims also fall within the scope of the present disclosure.

### DESCRIPTION OF SYMBOLS

stack cell 100, battery cell 110, elastic member 120, positive electrode 111, positive electrode current collecting layer 111a, positive electrode active material layer 111b, first positive electrode active material layer 11, second positive electrode active material layer 12, solid electrolyte layer 112, first solid electrolyte layer 17, second solid electrolyte layer 18, negative electrode 113, negative electrode current collecting layer 113a, first negative electrode current collecting layer 13, second negative electrode current collecting layer 14, negative electrode coating layer 113b, first negative electrode coating layer 15, second negative electrode coating layer 16, insulating member 300, positive electrode lead tab 400, negative electrode substrate tab 500, negative electrode lead tab 600

1. An all-solid rechargeable battery comprising:
a stack cell including a plurality of battery cells that are stacked and include a plurality of negative electrodes, a plurality of solid electrolyte layers, and a plurality of positive electrodes;
a plurality of positive electrode substrate tabs extending from each of the plurality of positive electrodes of the stack cell; and
a plurality of insulating members surrounding and insulating each of the plurality of positive electrode substrate tabs.

2. The all-solid rechargeable battery of claim 1, wherein:
the positive electrode substrate tab has a tab bending portion that is bent, and
the insulating member is disposed on the tab bending portion.

3. The all-solid rechargeable battery of claim 2, wherein:
an edge of the negative electrode protrudes by a protruding portion compared to an edge of the positive electrode, and
a portion of the insulating member is disposed, while overlapping the protruding portion.

4. The all-solid rechargeable battery of claim 3, wherein:
a portion of the insulating member is disposed in a recessed portion surrounded by the edge of the positive electrode and a solid electrolyte layer adjacent to the edge of the positive electrode.

5. The all-solid rechargeable battery of claim 4, wherein:
at least a portion of the insulating member is in contact with the solid electrolyte layer forming the recessed portion.

6. The all-solid rechargeable battery of claim 4, wherein:
a width of the insulating member is greater than a width of the recessed portion.

7. The all-solid rechargeable battery of claim 3, further comprising a positive electrode lead tab to which the plurality of positive electrode substrate tabs are connected together,
wherein the positive electrode substrate tab comprises
a positive electrode tab one end connected to the edge of the positive electrode,
a positive electrode tab other end connected to the edge of the positive electrode lead tab, and
a positive electrode tab connection portion connecting the positive electrode tab one end and the positive electrode tab other end, and
the tab bending portion is disposed at the positive electrode tab one end.

8. The all-solid rechargeable battery of claim 7, further comprising:
a plurality of negative electrode substrate tab respectively extending from the plurality of negative electrodes of the stack cell; and
a negative electrode lead tab to which the plurality of negative electrode substrate tabs are connected together.

9. The all-solid rechargeable battery of claim 1, wherein:
the positive electrode comprises
a positive electrode current collecting layer and
a first positive electrode active material layer and a second positive electrode active material layer disposed on both sides of the positive electrode current collecting layer, and
the positive electrode substrate tab extends from the positive electrode current collecting layer.

10. The all-solid rechargeable battery of claim 9, wherein:
the positive electrode substrate tab includes the same material as the positive electrode current collecting layer.

11. The all-solid rechargeable battery of claim 10, wherein:
the positive electrode substrate tab is integrally formed with the positive electrode current collecting layer.

12. The all-solid rechargeable battery of claim 1, wherein:
the positive electrode comprises
a positive electrode current collecting layer and a positive electrode active material layer disposed on one side of the positive electrode current collecting layer,
the positive electrode substrate tab extends from the positive electrode current collecting layer, and a thickness of the positive electrode substrate tab is smaller than a thickness of the positive electrode current collecting layer.

13. The all-solid rechargeable battery of claim 12, wherein:
the positive electrode substrate tab includes the same material as the positive electrode current collecting layer.

14. The all-solid rechargeable battery of claim 1, wherein:
the stack cell further comprises an elastic member disposed between adjacent battery cells.

15. The all-solid rechargeable battery of claim 1, wherein:
the insulating member includes an insulation layer coated on the positive electrode substrate tab or an insulating tape surrounding the positive electrode substrate tab.
